(19) United States
(12) Patent Application Publication
(10) Pub. No.: US 2015/0358502 A1
(43) Pub. Date: Dec. 10, 2015

(54) METHODS AND APPARATUS FOR MANAGEMENT OF SOFTWARE APPLICATIONS

(71) Applicants: Jayasimha Nuggehalli, Cupertino, CA (US); Jiang Hong, San Jose, CA (US); Zhenyu Lu, Sunnyvale, CA (US); Guiluan Luo, Dublin, CA (US); Revathi Vulugundam, San Jose, CA (US)

(72) Inventors: Jayasimha Nuggehalli, Cupertino, CA (US); Jiang Hong, San Jose, CA (US); Zhenyu Lu, Sunnyvale, CA (US); Guiluan Luo, Dublin, CA (US); Revathi Vulugundam, San Jose, CA (US)

(73) Assignee: RICOH COMPANY, LTD., Tokyo (JP)

(21) Appl. No.: 14/827,640

(22) Filed: Aug. 17, 2015

Related U.S. Application Data
(63) Continuation of application No. 12/817,055, filed on Jun. 16, 2010.

(51) Int. Cl. H04N 1/34; H04N 1/00; H04L 12/58; G06K 9/00; G06Q 40/00; G06Q 30/02

(52) U.S. Cl. CPC H04N 1/344; G06Q 40/12; G06Q 30/0283; H04L 51/14; G06K 9/00993; H04N 1/00244; H04N 1/00344; G06K 2209/01; H04N 2201/0094

(57) ABSTRACT

Methods and apparatus are provided for monitoring usage of a Software As A Service (SAAS) application for post-processing of scanned data generated by a client device (e.g., MFPs). A management system receives a pricing model for an SAAS application, where the pricing model includes a post-post processing feature of the SAAS application available to a user of the client device. The pricing model also includes information identifying a price for use of the post-processing feature. Information is received by the management system regarding use of the post-processing feature by the user, and a revenue report is generated regarding the post-processing feature.

### RELATED PATENTS

This patent application is a continuation of U.S. patent application Ser. No. 12/817,055 filed on Jun. 16, 2010 and entitled “METHODS AND APPARATUS FOR MONITORING SOFTWARE AS A SERVICE APPLICATIONS”, which is hereby incorporated by reference.

### BACKGROUND

1. Field of the Invention

The invention relates generally to enterprises using networked applications, and more specifically, relates to methods and apparatus for monitoring Software As A Service (SAAS) applications for post-processing of scanned data generated by client devices such as a multi-function device (e.g., a multi-function printer, scanner, copier device).

2. Discussion of Related Art

A number of software vendors provide their software products as a service that may be accessed via a network connection between a client system and a server system. The server system provides the application software as a service to one or more client systems accessing the server through the intermediate network (e.g., the Internet or an enterprise intranet). In general, a client system contacts an appropriate server system that provides desired application software as a service and commences utilizing the application software in cooperation between the client system and the server system.

Some solutions exist to extend the concept of software as a service to multi-function devices coupled to a server system through an intermediate network, such as the Lexmark Corporation “smart solutions.” As used herein, multi-function device refers to any device that provides a combination of printing, scanning, and/or copying functions and typically includes some form of user interface integral within the multi-function device for interacting with a user of the device. Multi-function devices are also frequently referred to as multi-function printers or simply MFP devices.

One task generally assigned to system administrators of MFP devices is coordinating accounting charges for users of the MFP devices for activities such as print and scan jobs. For example, users may pay charges for printing on an MFP device, or may pay charges for scanning documents on an MFP device. The charges may be based on the job control settings on the MFP device used to perform the print and/or scan functionality. While controlling the accounting based assessment for such activities based on the job control settings on each MFP device may be sufficient for simple accounting of print/scan jobs, such simplistic accounting lacks the flexibility to charge for the variety of SAAS application functions available to the user.

Thus, it is an ongoing challenge to provide flexibility in an SAAS environment for monitoring and charging for a wide variety of features used in SAAS applications.

### SUMMARY

The present invention solves the above and other problems, thereby advancing the state of the useful arts, by providing methods and apparatus for monitoring usage of a Software As A Service (SAAS) application for post-processing of scanned data generated by a client device (e.g., an MFP). A management system receives a pricing model for an SAAS application, where the pricing model includes a post-processing feature of the SAAS application available to a user of the client device. The pricing model also includes information identifying a price for use of the post-processing feature. Information is received by the management system regarding use of the post-processing feature by the user, and a revenue report is generated regarding use of the post-processing feature.

One aspect hereof provides a software management system operable to monitor a usage of a Software As A Service (SAAS) application for post-processing scanned data. The system includes an application provider interface operable to receive a pricing model for the SAAS application, the pricing model including information identifying a post-processing feature of the SAAS application available for use by a user of a client device for post-processing of scanned data generated by the client device, and the pricing model including information identifying a price for use of the post-processing feature by the user. The system further includes a storage device communicatively coupled with the application provider interface. The storage device stores a database, where the database is operable to record the pricing model for the SAAS application. The application provider interface is further operable to receive information regarding use of the post-processing feature of the SAAS application by the user of the client device. The database is further operable to record the information regarding use of the post-processing feature in the database. The system further includes a report generator communicatively coupled with the storage device and the application provider interface. The report generator is operable to output a revenue report regarding the post-processing feature based on the pricing model for the SAAS application recorded in the database and based on the information regarding use of the post-processing feature of the SAAS application recorded in the database.

Another aspect hereof provides a method operable in a computing system for monitoring usage of an SAAS application for post-processing scanned data. The method comprises receiving, in the computing system, a pricing model for the SAAS application, the pricing model including information identifying a post-processing feature of the SAAS application available for use by a user of a client device for post-processing of scanned data generated by the client device, and the model including information identifying a price for use of the post-processing feature by the user. The method further comprises recording, by operation of the computing system, the pricing model for the SAAS application in a database associated with the computing system. The method further comprises receiving, in the computing system, information regarding use of the post-processing feature of the SAAS application by the user of the client device. The method further comprises recording, by operation of the computing system, the information regarding use of the post-processing feature in the database. The method further comprises outputting, by operation of the computing system, a revenue report regarding the post-processing feature based on the pricing model for the SAAS application recorded in the database and based on the information regarding use of the post-processing feature of the SAAS application recorded in the database.

### BRIEF DESCRIPTION OF THE DRAWINGS

The same reference number represents the same element or same type of element on all drawings.

FIG. 1 is a block diagram of an exemplary software application management system in accordance with features and aspects hereof to monitor usage of an SAAS application for post-processing of scanned data generated by a client device.

FIG. 2 is a block diagram of another exemplary software application management system in accordance with features and aspects hereof to monitor usage of an SAAS application for post-processing of scanned data generated by a client device.

FIG. 3 is a flowchart describing an exemplary method for monitoring usage of an SAAS application for post-processing of scanned data generated by a client device.

FIG. 4 is an exemplary screen display for a menu of software application features that may be monitored for usage by a user of a client device.

FIG. 5 is an exemplary screen display of a menu for assigning a price for features of an SAAS application.

FIG. 6 is an exemplary screen display of a usage report showing usage of post-processing features of a software application.

FIG. 7 is a block diagram of a software application management system on which a computer readable medium may be used to receive program instructions for a method to monitor usage of an SAAS application for post-processing of scanned data generated by a client device.

### DETAILED DESCRIPTION OF THE DRAWINGS

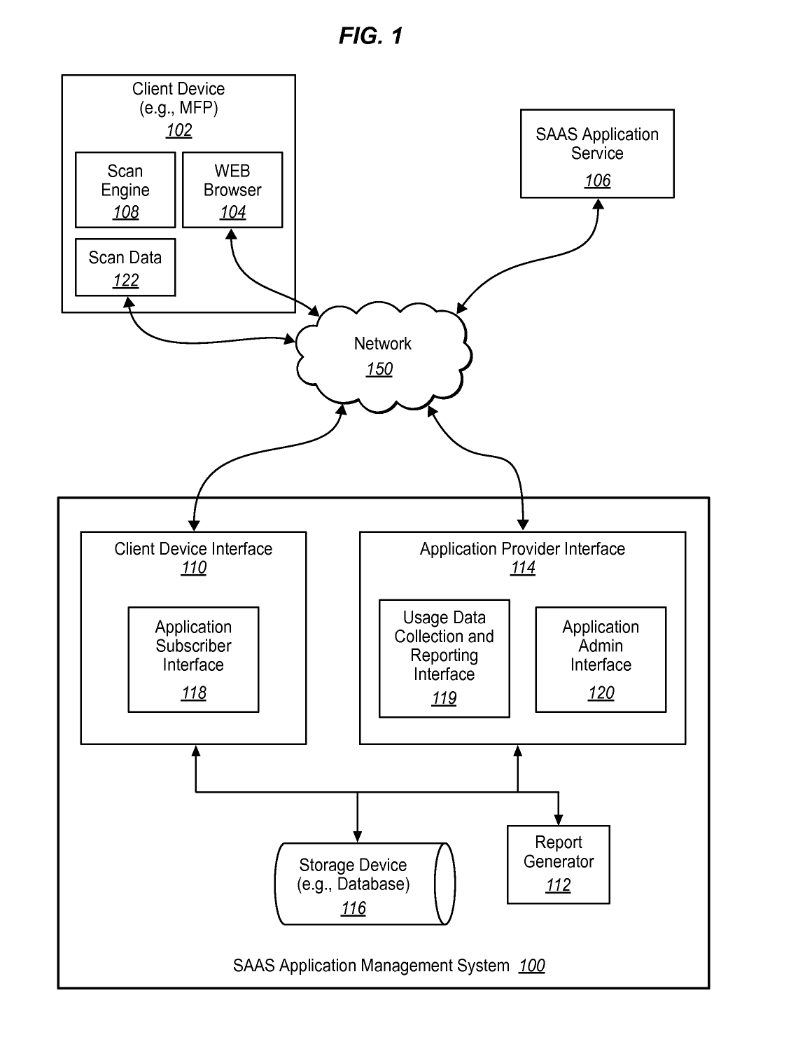

FIGS. 1 through 7 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of an exemplary SAAS application management system 100 enhanced in accordance with features and aspects hereof to monitor usage of an SAAS application for post-processing scan data 122 generated by a client device 102 (e.g., by scan engine 108). System 100 includes client device interface 110 for exchanging information with client device 102 via network 150. System 100 also includes application provider interface 114 for exchanging information with application service 106 via network 150. Network 150 may be any suitable network connection including, for example, appropriate coupling to the Internet, or coupling to an enterprise's intranet. Further, there can be any number of SAAS application services 106 coupled to management system 100 through network 150. In like manner, any number of client devices 102 coupled to management system 100 through network 150.

Client device 102 may be any device adapted for utilizing an SAAS application provided by the SAAS application service 106. In particular, client device 102 may be a multi-function device (often referred to as a multi-function printer or MFP) adapted for utilizing SAAS applications for post-processing scan data 122. SAAS application service 106 may be any suitable computing device that provides one or more software applications as a service for use by one or more client devices 102. In general, client device 102 and SAAS application service 106 communicate directly through network 150 (or other suitable communication media) performing the functions of a particular SAAS application program.

Management system 100 may be any suitable computing device capable of coupling with network 150 to exchange application information with SAAS application service 106 (via application provider interface 114) and to exchange subscription information with client device 102 (via client device interface 110).

In general, application information exchanged between SAAS application service 106 and management system 100 may include information identifying, or otherwise associated with, one or more available application programs available from an application provider operating SAAS application service 106, and may include information regarding the use of particular features of an SAAS application by a user of client device 102, such as post-processing features. Post-processing features available to the user may include various activities regarding post-processing scan data 122 of client device 102, such as Optical Character Recognition (OCR) on scan data 122, language translations on scan data 122, and the like. In general, a scan engine 108 of client device performs an imaging process on various physical media, such as paper media, business card media, pre-printed form media, receipt media, and the like, to generate scan data 122. Scan data 122 may represent color/black-and-white digital representations of the media in a number of well-known formats, such as a Tagged Image File Format (TIFF), Joint Photographic Experts Group (JPEG), a raw image format, etc. An application administration interface 120 may interact with an administrative user associated with the application service provider to define a pricing model for post-processing features of an SAAS application for post-processing scan data 122. The pricing model may include information identifying the post-processing feature of the SAAS application, and may include information identifying a price for use of the post-processing feature by the user. In addition, SAAS application service may provide usage information to management system 100 through usage data collection and reporting interface 119. The usage information received from application service 106 by interface 119 may indicate whether a particular post-processing feature of the application has been used by a client device and/or may indicate the amount of a particular post-processing feature that was used by a client device. Usage data collection and reporting interface 119 may also receive a request from an application service 106 (or from an administrative user) to generate and return a revenue report regarding usage of various post-processing features provided by the SAAS applications.

Available application information is generated by management system 100 and transmitted to the user of client device 102 through client device interface 110 and the application subscription interface 118. For example, the user of client device 102 may logon to management system 100 using a personal computer through a web browser. After management system 100 authenticates the user, a list of applications available from one or more SAAS application services 106 for subscription by the user of client device 102 may be presented to the user. For each available application, an application ID may be provided to the client device 102 as well as name information, cost information, a graphical logo to represent the application, etc.

Information regarding available applications and regarding subscriptions by identified client devices 102 to one or more applications may be stored in a database of storage device 116 of management system 100. Storage device 116 generally stores such information in the database to allow rapid, indexed access to the information based on client device identification, application identification, and/or other key indicia. Storage device 116 may be, for example, a disk drive or other suitable mass storage device for managing such information in a reliable, secure storage. The database on storage device 116 may also utilized for storing usage information including information pertaining to usage of post-processing features of various SAAS applications.

Management system 100 further includes a report generator module 112 operable in response to requests for reports received through the application provider interface 114 via application admin interface 120 or through client interface 110. A request for a report may include any of a variety of standard report formats including, for example, usage of one or more applications by one or more identified client devices, revenues associated with such usage, etc.

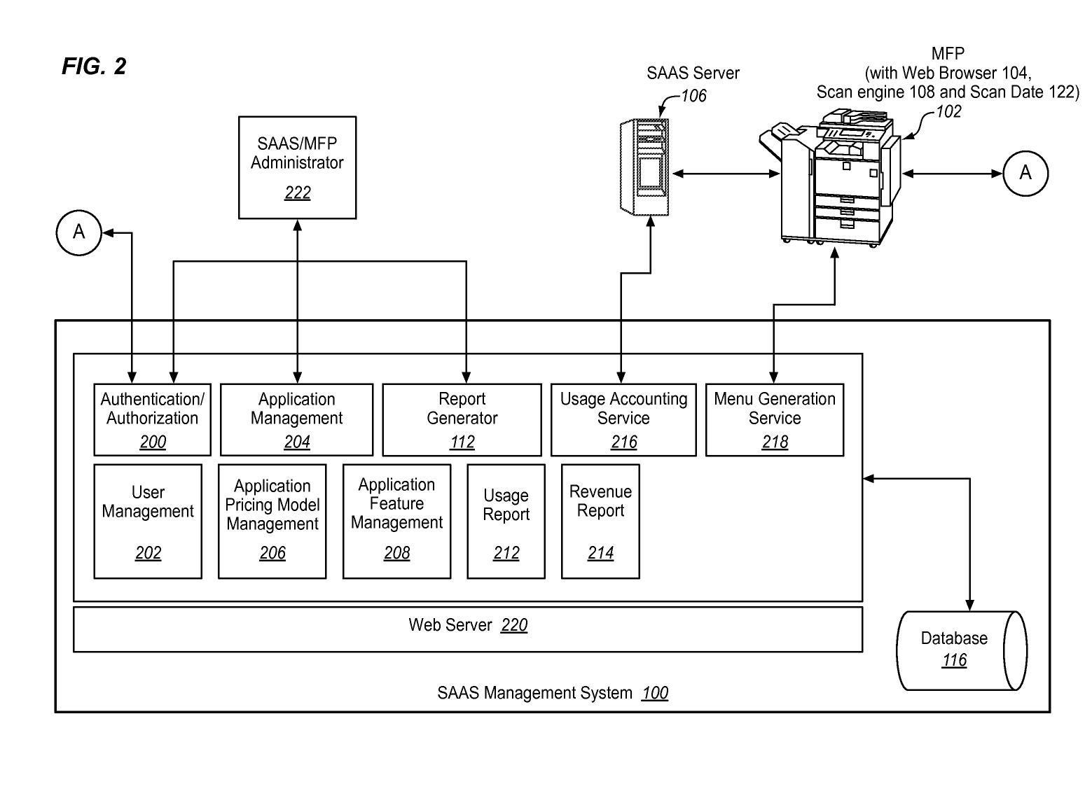

FIG. 2 is a block diagram depicting another exemplary embodiment of SAAS management system 100 providing additional details of an exemplary modular decomposition within management system 100. As above with respect to FIG. 1, management system 100 may be coupled with an application service 106 and MFP 102 (which, in turn, includes a Web browser 104). As noted above, the coupling of management system 100 to application service 106 and/or MFP 102 may utilize any suitable connectivity including, for example, Internet connectivity.

Application service 106 provides networked applications for users of MFP 102 and may provide various post-processing services to users of MFP 102. For example, when MFP 102 generates scan data 122 using scan engine 108, MFP 102 may forward scan data 122 to application service 106 in response to a OCR application feature request from a user. Application service 106 may then perform the OCR post-processing function and return OCR data to MFP 102 or an alternate server for subsequent post-processing. Alternatively, MFP 102 may convert scan data 122 to OCR data, and then forward the OCR data to one or more application servers 106 for other post-processing functions described herein.

Management system 100 may also be coupled with an SAAS/MFP administrator 222 utilizing any suitable interactive communication with an administrative user. An authentication/authorization module 200 provides for secure login for the administrative user 222. In addition, authentication/authorization module 200 may provide secure login capabilities to authenticate a user of MFP 102 interacting through Web browser 104. Once authenticated through authorization/authentication module 200, administrative user 222 may perform user management functions utilizing user management module 202 to interact with application pricing model management module 206 and application feature management module 208. Application pricing model management module 206 provides the administrative user with interaction to create a pricing model to be associated with usage of post-processing features of SAAS applications subscribed to by the user of MFP 102. For example, administrative user 222 may utilize application pricing management module 206 to define an OCR or other post-processing feature for an SAAS application to process scan data 108. OCR post-processing features for an SAAS application may include forwarding the OCR data generated by performing an OCR process on scan data 122 to a storage system (not shown in FIG. 2) or an email system (also not shown in FIG. 2). Additional OCR post-processing features may include identifying contact information from the OCR data (as by scanning a business card, pre-printed form, etc.), forwarding the OCR data to an accounting system or a database (when the OCR data includes sales data or other accounting/business related data). Further, administrative user 222 may utilize application pricing management module 206 to define an OCR post-processing feature for the SAAS application for performing a translation from one language to another language (e.g., translating OCR data from English to French, etc.). The pricing model information may be stored in database 116 for use by other modules within management system 100.

Usage accounting service 216 receives usage information from SAAS application service 106 indicating usage detected by service 106 in providing the post-processing features of an application to a user of MFP 102. For example, a user of MFP 102 may select an application for providing OCR or other post-processing features for a printed document. Service 106 identifies the usage and provides the usage information to management system 100 via usage accounting service 216. The usage information may then be recorded in database 116.

An authenticated administrative user 222 or an authenticated user of MFP 102 may interact through report generator 212 to generate a usage report utilizing usage report module 212 and/or a revenue report utilizing revenue report module 214. Usage report module 212 and revenue report module 214 retrieve information from database 116 to generate and return a requested report from report generator 112 to a requesting administrative user 222 or user of MFP 102.

Menu generation service 218 utilizes information in database 116 regarding applications available through management system 100. Based on authentication/authorization information obtained through module 200 from the MFP 102, menu generation service 218 may provide a menu of subscribed SAAS applications for a particular user or group of users of MFP 102. These and other menus may be generated based on information stored in database 116 and provided to MFP 102 in response to a request from MFP 102.

Exemplary details of the information exchanged between management system 110 administrative user 222 and service 106 or between management system 100 and MFP 102 are discussed further herein below. Numerous additional and equivalent modules may be present in a particular embodiment of management system 100. Further, fewer or more modules may be defined within management system 100 in any particular modular decomposition of exemplary embodiments as a matter of design choice. Thus, the system of FIGS. 1 and 2 are intended merely as exemplary of possible embodiments in accordance with features and aspects hereof

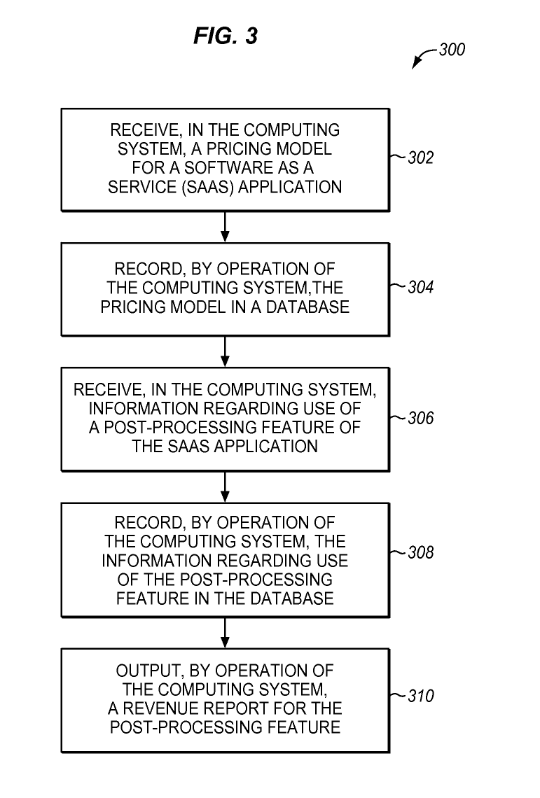

FIG. 3 is a flowchart describing an exemplary method 300 for monitoring usage of an SAAS application for post-processing of scanned data generated by a client device. In general, method 300 is operable in management system 100 of FIGS. 1 and 2. The management system is responsive to exchanges with client devices and/or application services as well as administrative users configuring the management system. The various requests and responses may be encoded in any suitable protocols including, for example, HTML pages communicated utilizing HyperText Transfer Protocol HTTP exchanges, WEB 2.0 services, etc.

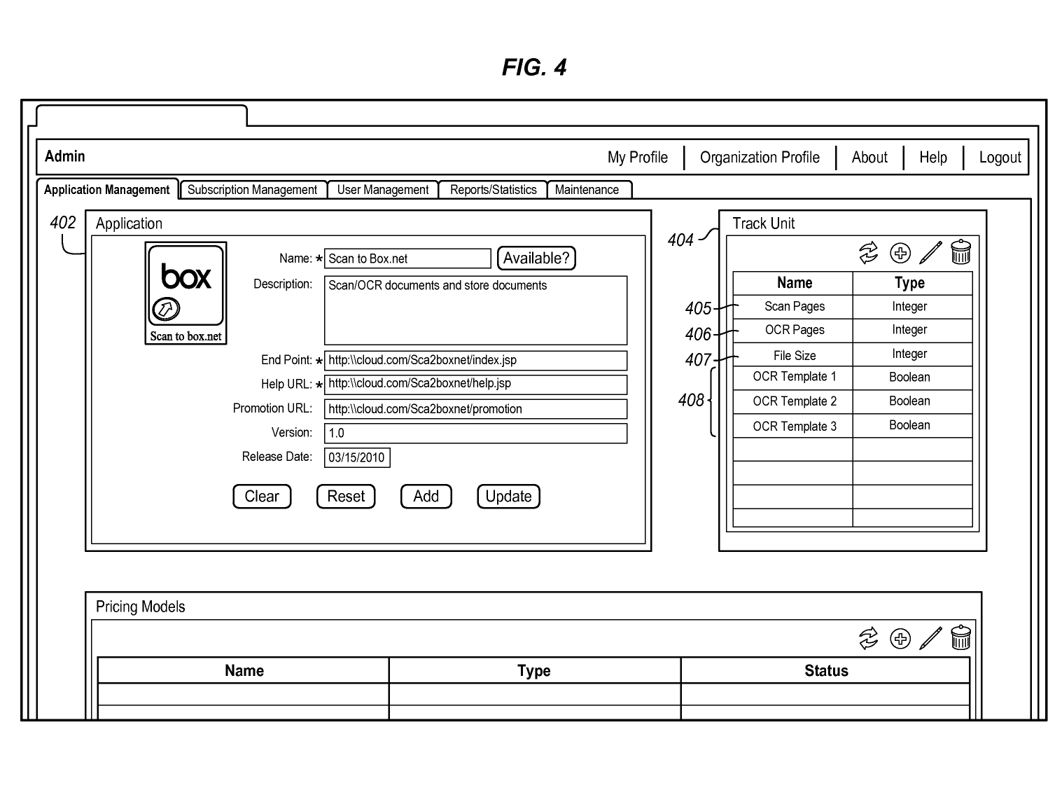

Step 302 of method 300 comprises receiving, in a computing system, a pricing model for an SAAS application. As discussed, the pricing model may include information identifying a post-processing feature of the application and information identifying a price for use of the post-processing feature by the user of the client device. FIG. 4 is an exemplary screen display of a menu for identifying post-processing features for a software application that may be monitored for usage by a user of a client device. Application tab 402 allows an authenticated administrator to select a specific SAAS application to track usage information for. The authenticated user may, for example, browse through a list of existing SAAS applications available for subscription by a user of the client device, and select one. In the example, application tab 402 allows the administrator to select for selecting an application to generate or modify tracking information for. In this example, application tab 402 indicates that the selected application is “scan to box.net.” The “scan to box.net” application may provide, for example, a remote data repository for scan data or OCR data generated by the client device. FIG. 4 also illustrates a tracking unit tab 404 for defining tracking units associated with the application. Tracking unit tab 404 includes a user-friendly name for a post-processing feature to track, such as tracking scan pages 405, tracking OCR pages 406, and tracking a file size 407. Tracking unit tab 404 also includes OCR templates 408. OCR templates are used to identify the underlying data of a document to be scanned. For example, an OCR template may identify specific fields of a typical sales receipt for importing data into a database. The fields may identify an item description and an item price. Tracking a file size 407 may be utilized to determine a charge for storage of an output for the “scan to box.net” application. For each of the post-processing features to track, (i.e., 405-408) there is a corresponding unit type. The unit type may be an integer, a Boolean, or another type. In the example, scan pages 405 has a type integer. An integer type tracks the number of uses of a post-processing feature, such as a number of pages scanned, a number of pages processed by an OCR feature, etc. A Boolean type is a true or false value indicating if a specific feature is used or not.

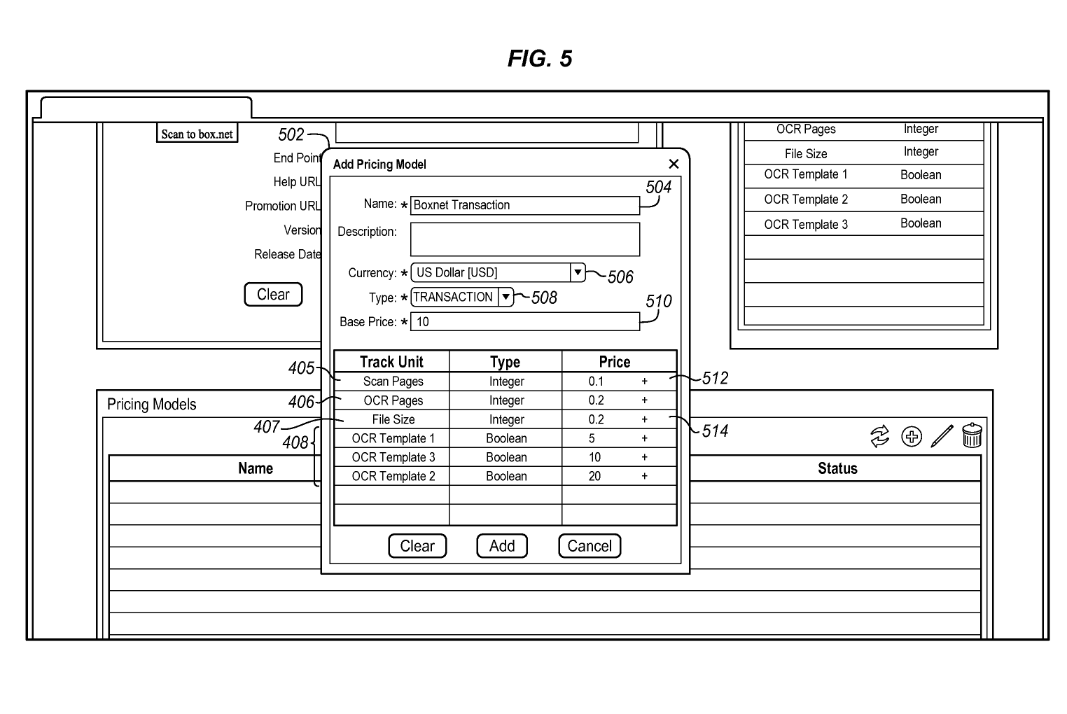

FIG. 5 is an exemplary screen display of a menu for assigning pricing information for tracked post-processing features of a software application within the pricing model. A pricing model tab 502 allows the administrator to generate or modify a pricing model associated with the currently selected application. In the example, the pricing model is given a name 504 of “boxnet transaction,” which is a pricing model associated with the “scan to box.net” application. An administrator may then select a currency 506 for the pricing model. In the example, the currency is U.S. Dollars (USD). The previously defined post processing features to track may then be assigned a price for usage. In the example, scan page 405 post processing feature has an integer price 512 of 0.1 USD. File size 407 post-processing feature has an integer price 514 of 0.2 USD for each 5 Megabytes of storage.

Referring again to method 300 of FIG. 3, step 304 comprises recording, by operation of the computing system, the pricing model (e.g., “boxnet transaction” of FIG. 5) in the database. Step 306 comprises receiving, in the computing system, information regarding the use of a post-processing feature of the SAAS application. In continuing with the example of the “scan to box.net” application of FIG. 4, a user of the client device may generate scan data of a document on the client device, and may select the “scan to box.net” application on a display of the client device. Further, the user may elect to perform an OCR process (e.g., select OCR pages 406 feature). In some embodiments, the client device may perform the OCR processing of the scan data. In other embodiments, the client device may forward the scan data to a server (e.g., a server hosting the “scan to box.net” application). The server may then perform the OCR processing of the scan data, return the OCR data to the client device or another server for subsequent post-processing, and transmit usage information to the management system regarding the use of the OCR post-processing feature.

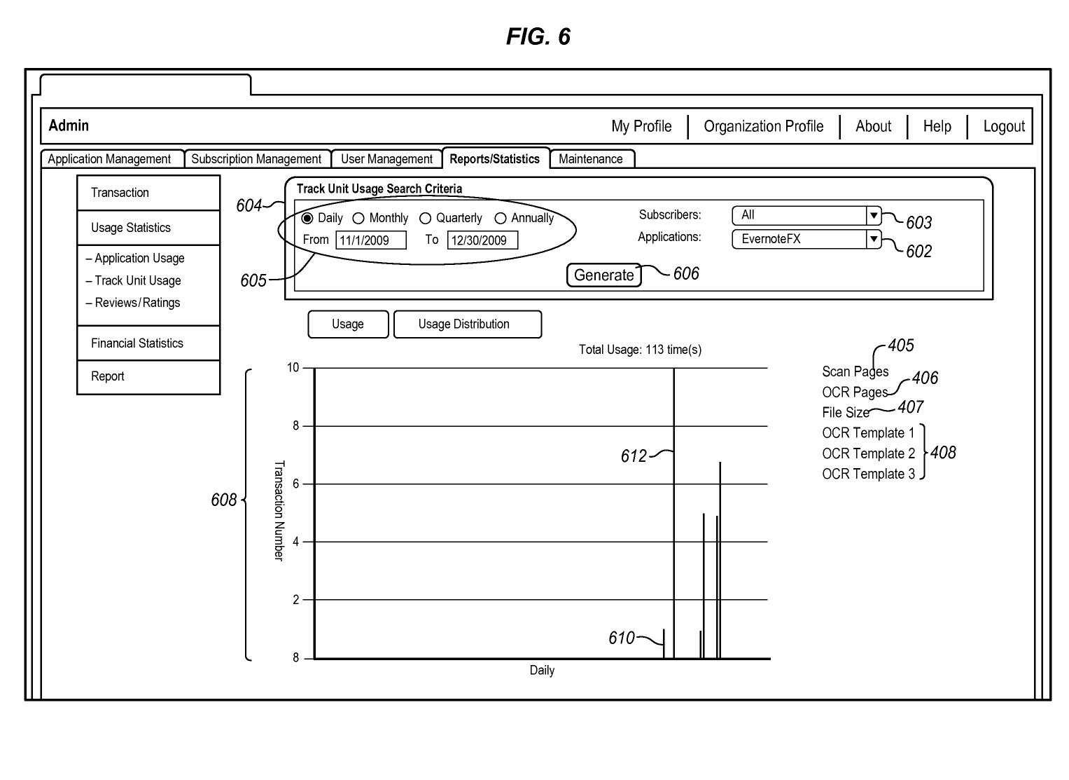

Step 308 of method 300 comprises recording, by operation of the computing system, the information regarding use of a post-processing feature in the database. Step 310 comprises outputting, by operation of the computing system, a revenue report for a post-processing feature. The report may be generated, for example, as an HTML page to be presented on a suitable Web browser of a computer operated by the requesting user. The request may be generated by an administrative user authorized and authenticated for use of the management system and/or may be generated automatically by the server computing system of the application service provider. FIG. 6 is an exemplary screen display of a usage report showing usage of post-processing features of a software application. In FIG. 6, an administrator may select a search criteria 604 for generating the revenue report. Search criteria 604 includes selecting a specific application 602, selecting subscribers 603 (useful for filtering reports based on applications the organization is subscribed to), and selecting a range of dates 605 to include in the revenue report. The management system generates the revenue report based on the selected criteria when the administrator operates the generate button 606. The usage of post processing features 405-408 (e.g., a number of transactions for each of the post-processing features) for the report is displayed in a report window 608. In report window 608, transaction 610 corresponds with a usage of the scan pages 405 post-processing feature. In like manner, transaction 612 corresponds with a usage of the OCR pages 406 post-processing feature.

Those of ordinary skill in the art will readily recognize numerous additional and equivalent steps in the methods of FIG. 3. Such additional and equivalent steps are omitted herein for simplicity and brevity of this discussion.

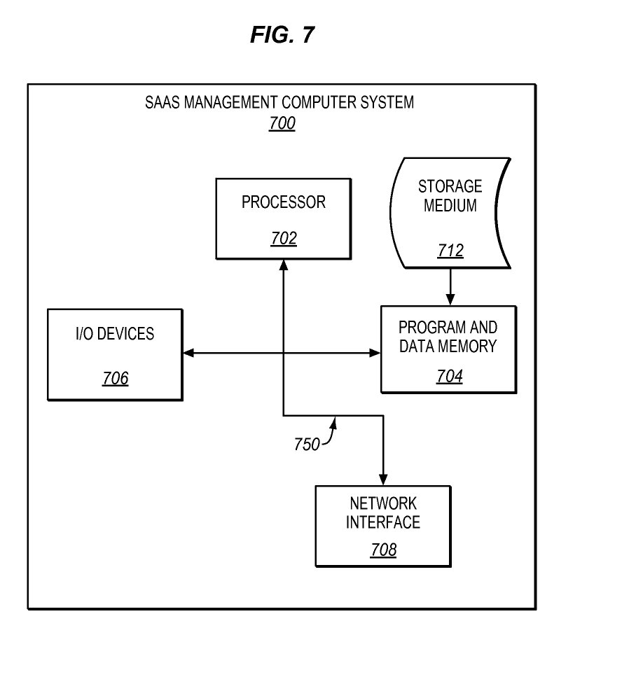

Embodiments of the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 7 is a block diagram depicting an SAAS management computing system 700 adapted to provide features and aspects hereof by executing programmed instructions and accessing data stored on a computer readable storage medium 712.

Furthermore, embodiments of the invention can take the form of a computer program product accessible from a computer-usable or computer-readable medium 712 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

AN SAAS management computer system 700 suitable for storing and/or executing program code will include at least one processor 702 coupled directly or indirectly to memory elements 704 through a system bus 750. The memory elements 704 can include local memory employed during actual execution of the program code, bulk storage, and cache memories that provide temporary storage of at least some program code in order to reduce the number of times code must be retrieved from bulk storage during execution.

Input/output or I/O devices 706 (including but not limited to keyboards, displays, pointing devices, etc) can be coupled to the system either directly or through intervening I/O controllers. Network adapter interfaces 708 may also be coupled to the system to enable the SAAS management computer system 700 to be coupled with other data processing systems or storage devices through intervening private or public networks. Modems, cable modems, IBM Channel attachments, SCSI, Fibre Channel, and Ethernet cards are just a few of the currently available types of network or host interface adapters.

Although specific embodiments were described herein, the scope of the invention is not limited to those specific embodiments. The scope of the invention is defined by the following claims and any equivalents thereof.

We claim:

1. A system, comprising:
a Multi-Function Printer (MFP) configured to utilize Software As A Service (SAAS) applications;
a SAAS application server that is configured to provide a SAAS application to the MFP that includes Optical Character Recognition (OCR) capabilities; and
a Software As A Service (SAAS) manager;
the MFP configured to generate scanned data of a document, and to utilize the OCR capabilities to generate OCR data from the scanned data;
the SAAS application server configured to monitor a use of the OCR capabilities of the SAAS application by the MFP, and to provide information regarding the use of the OCR capabilities to the SAAS manager;
the SAAS manager configured to identify a cost assigned to the OCR capabilities, and to generate a revenue report based on the cost assigned to the OCR capabilities and the use of the OCR capabilities by the MFP.

2. The system of claim 1 wherein:
the SAAS application provides forwarding capabilities to the MFP;
the MFP is configured to utilize the forwarding capabilities to provide the OCR data to a storage system;
the SAAS application server is configured to monitor a use of the forwarding capabilities by the MFP, and to provide information regarding the use of the forwarding capabilities to the SAAS manager; and
the SAAS manager is configured to identify a cost assigned to the forwarding capabilities, and to generate a revenue report based on the cost assigned to the forwarding capabilities and the use of the forwarding capabilities by the MFP.

3. The system of claim 2 wherein:
the scanned data comprises a scanned pre-printed form including user data; and
the MFP is configured to utilize the forwarding capabilities to provide the user data to the storage system.

4. The system of claim 1 wherein:
the SAAS application provides forwarding capabilities to the MFP;
the MFP is configured to utilize the forwarding capabilities to provide the OCR data to an email system;
the SAAS application server is configured to monitor a use of the forwarding capabilities by the MFP, and to provide information regarding the use of the forwarding capabilities to the SAAS manager; and
the SAAS manager is configured to identify a cost assigned to the forwarding capabilities, and to generate a revenue report based on the cost assigned to the forwarding capabilities and the use of the forwarding capabilities by the MFP.

5. The system of claim 4 wherein:
the scanned data comprises a scanned pre-printed form including user data; and
the MFP is configured to utilize the forwarding capabilities to provide the user data to the email system.

6. The system of claim 1 wherein:
the SAAS application provides forwarding capabilities to the MFP;
the MFP is configured to utilize the forwarding capabilities to provide the OCR data to an accounting system;
the SAAS application server is configured to monitor a use of the forwarding capabilities by the MFP, and to provide information regarding the use of the forwarding capabilities to the SAAS manager; and
the SAAS manager is configured to identify a cost assigned to the forwarding capabilities, and to generate a revenue report based on the cost assigned to the forwarding capabilities and the use of the forwarding capabilities by the MFP.

7. The system of claim 6 wherein:
the scanned data comprises a scanned sales receipt including sales data; and
the MFP is configured to utilize the forwarding capabilities to provide the sales data to the accounting system.

8. The system of claim 1 wherein:
the SAAS application provides contact identification capabilities to the MFP;
the MFP is configured to utilize the contact identification capabilities to identify contact information from the OCR data;
the SAAS application server is configured to monitor a use the contact identification capabilities by the MFP, and to provide information regarding the use of the contact identification capabilities to the SAAS manager; and
the SAAS manager is configured to identify a cost assigned to the contact identification capabilities, and to generate a revenue report based on the cost assigned to the contact identification capabilities and the use of the contact identification capabilities by the MFP.

9. The system of claim 1 wherein:
the SAAS application provides language translation capabilities to the MFP;
the MFP is configured to utilize the language translation capabilities to translate the OCR data from a first language to a second language;
the SAAS application server is configured to monitor a use the language translation capabilities by the MFP, and to provide information regarding the use of the language translation capabilities to the SAAS manager; and
the SAAS manager is configured to identify a cost assigned to the language translation capabilities, and to generate a revenue report based on the cost assigned to the language translation capabilities and the use of the language translation capabilities by the MFP.

10. A method, comprising:
providing, by a Software As A Service (SAAS) application server, a SAAS application to a Multi-Function Printer (MFP) that includes Optical Character Recognition (OCR) capabilities;
generating, by the MFP, scanned data of a document;
utilizing, by the MFP, the OCR capabilities to generate OCR data from the scanned data;
monitoring, by the SAAS application server, a use of the OCR capabilities of the SAAS application by the MFP;
providing, by the SAAS application server, information regarding the use of the OCR capabilities to a SAAS manager;
identifying, by the SAAS manager, a cost assigned to the OCR capabilities; and
generating, by the SAAS manager, a revenue report based on the cost assigned to the OCR capabilities and the use of the OCR capabilities by the MFP.

11. The method of claim 10 wherein:
the SAAS application provides forwarding capabilities to the MFP; and
the method further comprises:
utilizing, by the MFP, the forwarding capabilities to provide the OCR data to a storage system;
monitoring, by the SAAS application server, a use of the forwarding capabilities by the MFP;
providing, by the SAAS application server, information regarding the use of the forwarding capabilities to the SAAS manager;
identifying, by the SAAS manager, a cost assigned to the forwarding capabilities; and
generating, by the SAAS manager, a revenue report based on the cost assigned to the forwarding capabilities and the use of the forwarding capabilities by the MFP.

12. The method of claim 11 wherein:
the scanned data comprises a scanned pre-printed form including user data; and
the method further comprises:
utilizing, by the MFP, the forwarding capabilities to provide the user data to the storage system.

13. The method of claim 10 wherein:
the SAAS application provides forwarding capabilities to the MFP; and
the method further comprises:
utilizing, by the MFP, the forwarding capabilities to provide the OCR data to an email system;
monitoring, by the SAAS application server, a use of the forwarding capabilities by the MFP;
providing, by the SAAS application server, information regarding the use of the forwarding capabilities to the SAAS manager;
identifying, by the SAAS manager, a cost assigned to the forwarding capabilities; and
generating, by the SAAS manager, a revenue report based on the cost assigned to the forwarding capabilities and the use of the forwarding capabilities by the MFP.

14. The method of claim 13 wherein:
the scanned data comprises a scanned pre-printed form including user data; and
the method further comprises:
utilizing, by the MFP, the forwarding capabilities to provide the user data to the email system.

15. The method of claim 10 wherein:
the SAAS application provides forwarding capabilities to the MFP; and
the method further comprises:
utilizing, by the MFP, the forwarding capabilities to provide the OCR data to an accounting system;
monitoring, by the SAAS application server, a use of the forwarding capabilities by the MFP;
providing, by the SAAS application server, information regarding the use of the forwarding capabilities to the SAAS manager;
identifying, by the SAAS manager, a cost assigned to the forwarding capabilities; and
generating, by the SAAS manager, a revenue report based on the cost assigned to the forwarding capabilities and the use of the forwarding capabilities by the MFP.

16. The method of claim 15 wherein:
the scanned data comprises a scanned sales receipt including sales data; and
the method further comprises:
utilizing, by the MFP, the forwarding capabilities to provide the sales data to the accounting system.

17. The method of claim 10 wherein:
the SAAS application provides contact identification capabilities to the MFP; and
the method further comprises:
utilizing, by the MFP, the contact identification capabilities to identify contact information from the OCR data;
monitoring, by the SAAS application server, a use the contact identification capabilities by the MFP;
providing, by the SAAS application server, information regarding the use of the contact identification capabilities to the SAAS manager;
identifying, by the SAAS manager, a cost assigned to the contact identification capabilities; and
generating, by the SAAS manager, a revenue report based on the cost assigned to the contact identification capabilities and the use of the contact identification capabilities by the MFP.

18. The method of claim 10 wherein:
the SAAS application provides language translation capabilities to the MFP; and
the method further comprises:
utilizing, by the MFP, the language translation capabilities to translate the OCR data from a first language to a second language;
monitoring, by the SAAS application server, a use the language translation capabilities by the MFP;
providing, by the SAAS application server, information regarding the use of the language translation capabilities to the SAAS manager;
identifying, by the SAAS manager, a cost assigned to the language translation capabilities; and
generating, by the SAAS manager, a revenue report based on the cost assigned to the language translation capabilities and the use of the language translation capabilities by the MFP.

19. A non-transitory computer readable medium embodying programmed instructions which, when executed by a system comprising a Software As A Service (SAAS) application server, a Multi-Function Printer (MFP), and a SAAS manager, the instructions direct the system to:
provide, by the SAAS application server, a SAAS application to MFP that includes Optical Character Recognition (OCR) capabilities;
generate, by the MFP, scanned data of a document;
utilize, by the MFP, the OCR capabilities to generate OCR data from the scanned data;
monitor, by the SAAS application server, a use of the OCR capabilities of the SAAS application by the MFP;
provide, by the SAAS application server, information regarding the use of the OCR capabilities to the SAAS manager;
identify, by the SAAS manager, a cost assigned to the OCR capabilities; and
generate, by the SAAS manager, a revenue report based on the cost assigned to the OCR capabilities and the use of the OCR capabilities by the MFP.

20. The non-transitory computer readable medium of claim 19 wherein:
the SAAS application provides forwarding capabilities to the MFP; and
the instructions further direct the system to:
utilize, by the MFP, the forwarding capabilities to provide the OCR data to a storage system;
monitor, by the SAAS application server, a use of the forwarding capabilities by the MFP;
provide, by the SAAS application server, information regarding the use of the forwarding capabilities to the SAAS manager;
identify, by the SAAS manager, a cost assigned to the forwarding capabilities; and
generate, by the SAAS manager, a revenue report based on the cost assigned to the forwarding capabilities and the use of the forwarding capabilities by the MFP.
